(19) United States
(12) Patent Application Publication
(10) Pub. No.: US 2020/0372816 A1
(43) Pub. Date: Nov. 26, 2020

(54) METHODS FOR EVALUATING AND EDUCATING USERS

(71) Applicant: Anthony Frolov, Bell Canyon, CA (US)

(72) Inventor: Anthony Frolov, Bell Canyon, CA (US)

(21) Appl. No.: 16/417,093

(22) Filed: May 20, 2019

(51) Int. Cl. G09B 5/02; G06T 11/60

(52) U.S. Cl. CPC G09B 5/02; G06T 11/60

(57) ABSTRACT

Systems and methods for evaluating and educating a user are described herein. The method may commence with performing an initial evaluation of the user to establish initial skills with respect to an object or an action and selecting a skill development plan designed to improve the initial skills. The method may continue with providing the object or the action to the user according to the skill development plan. The method may further include determining that the user is perceiving the object or the action via an Augmented Reality (AR)-enabled user device. The method may further include ascertaining the identifier associated with the object or the action and activating an interactive session designed to improve the initial skills with respect to the object or the action. The method may further include performing a follow-up evaluation of the user to establish an improvement in at least one of the initial skills.

### TECHNICAL FIELD

The present disclosure relates generally to education and training and specifically to methods for evaluating a psycho-emotional state of a user and educating the user based on the psycho-emotional state.

### BACKGROUND

People who have mental disorders have specific behavioral patterns or disorders of a motor function and often respond to changes in their psycho-emotional state in a way that is invisible to others. For example, the behavior of people with an autism spectrum disorder or mental retardation differs significantly from the behavior of healthy people. It is difficult for an observer to determine how the psycho-emotional state of the people having the disorder changes. It is also difficult to understand the changes in the psycho-emotional state of a person with tonic regulation disorders, such as cerebral palsy, or of an elderly person.

In some cases, parents may face difficulties in determining whether a child has any signs of a mental disorder. Conventionally, the child needs to visit a doctor who tests the child to determine whether the child has a mental disorder. However, no technical solutions for evaluating the psycho-emotional state of a person by parents or teachers with further educating the person and developing skills of the person based on the current psycho-emotional state are provided.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are methods and systems for evaluating and educating a user. In some example embodiments, a method for evaluating and educating a user may commence with performing an initial evaluation of the user to establish initial skills with respect to an object or an action. The method may further include selecting a skill development plan for the user designed to improve the initial skills with respect to the object or the action. The method may further include providing, to the user, an augmented reality (AR) application for an AR-enabled user device. The method may continue with providing the object or the action to the user according to the skill development plan. The method may further include determining that the user is perceiving the object or the action via the AR-enabled user device. The object or the action may be associated with an identifier. The method may further include ascertaining the identifier associated with the object or the action by the AR application. The method may continue with activating, via the AR application, an interactive session designed to improve the initial skills with respect to the object or the action. The method may further include performing a follow-up evaluation of the user to establish an improvement in at least one of the initial skills.

In some example embodiments, a system for evaluating and educating a user may include an evaluation module configured to perform an initial evaluation of the user to establish initial skills with respect to an object or an action. The system may further include a skill development plan selected based on results of the evaluation. The skill development may be designed to improve the initial skills with respect to the object or the action. The system may further include an AR application designed to present, to the user via an AR-enabled user device, the object according to the skill development plan. The system may further include a processing module. The processing module may be configured to determine that the user is perceiving the object or the action via the AR-enabled user device. The object or the action may be associated with an identifier. The processing module may be configured to ascertain, by the AR application, the identifier associated with the object or the action. The processing module may be further configured to activate, on the AR-enabled user device, an interactive session designed to improve the initial skills with respect to the object or the action. The evaluation module may be further configured to perform a follow-up evaluation of the user to establish an improvement in at least one of the initial skills.

In some example embodiments, a non-transitory computer readable storage medium having embodied thereon a program executable by a processor to perform a method for evaluating and educating a user is provided. The method may commence with performing an initial evaluation of the user to establish initial skills with respect to an object or an action. The method may further include selecting a skill development plan for the user designed to improve the initial skills with respect to the object or the action. The method may further include providing, to the user, an AR application for an AR-enabled user device. The method may continue with providing the object or the action to the user according to the skill development plan. The method may further include determining that the user is perceiving the object or the action via the AR-enabled user device. The object or the action may be associated with an identifier. The method may further include ascertaining the identifier associated with the object or the action by the AR application. The method may continue with activating, via the AR application, an interactive session designed to improve the initial skills with respect to the object or the action. The method may further include performing a follow-up evaluation of the user to establish an improvement in at least one of the initial skills.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF THE DRAWINGS

Embodiments are illustrated by way of example and not limitation in the figures of the accompanying drawings, in which like references indicate similar elements and in which:

FIG. 1 illustrates an environment within which system and methods for evaluating and educating a user can be implemented, in accordance with some embodiments.

FIG. 2 is a block diagram showing various modules of a system for evaluating and educating a user, in accordance with certain embodiments.

FIG. 3 is a flow chart illustrating a method for evaluating and educating a user, in accordance with an example embodiment.

FIG. 4 is a schematic diagram illustrating a method for educating a user to develop an association between a visual representation of objects and real objects, according to an example embodiment.

FIG. 5 is a schematic diagram illustrating a method for educating a user to develop an association between a visual representation of actions and real actions, according to an example embodiment.

FIG. 6 is a schematic diagram illustrating a method for educating a user to develop an association between an audible representation of objects or actions and real objects or actions, according to an example embodiment

FIG. 7 is a schematic diagram illustrating a method for educating a user to develop a non-stereotypical behavior with regard to objects shown on a screen of a computing device, according to an example embodiment.

FIG. 8 shows a computing system that can be used to implement a method for evaluating and educating a user, according to an example embodiment.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

The present disclosure provides methods and systems for evaluating and educating a user. These methods and systems may be used by parents and teachers when conducting educatory, corrective, and development trainings for children and adults having autistic disorders, logopedic disorders, mental disorders, age-related disorders, and the like. The methods and systems may be applied to teach and socially adapt users and develop required skills of the users.

According to the method, a user, such as a child or an adult, may be initially evaluated to establish initial skills of the user with respect to an object or an action. The user may be tested to determine the level of knowledge and the level of retention of material of the user. Users having mental disorders may face difficulties in developing a correct association between a word denoting an action and the action itself or between a word denoting an object and the object itself. The evaluation of the user may include testing the user to determine whether the user understands the meaning of various objects and actions and is able to associate the objects and actions with similar objects and actions. The testing may include providing predetermined questions on a predetermined topic and receiving responses to the questions from the user. In an example embodiment, the evaluation of the user may be performed to determine whether the user likely has an autism spectrum disorder, a mental disorder, or the like, as well as the severity of the disorder. Furthermore, the results of evaluation may be provided to a teacher or a parent in accordance with a predetermined scale related to the autism spectrum disorders. The scale may be ranged from the state of a non-contact person to the state of a seemingly normal person having some autism-associated problems. The results of evaluation may show the likelihood of presence/absence of the disorder and the heaviness of the disorder.

Upon testing the user, a skill development plan may be selected or developed for the user. The skill development plan may be designed to improve the initial skills of the user with respect to the object or the action. The skill development plan may include a training program and a set of cards, stickers, or other items. The cards of the set may have images representing an object or an action. Each of the cards may have a tag associated with an AR application. The tag may include an identifier placed on the cards.

The user may have or may be provided with (e.g., by a teacher) an AR-enabled user device on which the AR application may be run. The user may direct a camera of the AR-enabled user device on the card. The camera may detect the identifier on the card and activate the AR application. The AR application may initiate an interactive session. The interactive session may include providing interactive animation materials, e.g., in form of an AR three-dimensional virtual game, to the user to improve the initial skills of the user with respect to the object or the action. The interactive animation materials may include a picture/animation of the object or the action and an explanation of the meaning, specific features, or purpose of the object or the action. The picture/animation of the object or the action may be displayed multiple times to the user to strengthen rote memorization of meaning of the object or the action. Each time the s-object or the action is displayed to the user, the appearance, such as color, size, and type of the object or the action, and location of the object or the action on a screen of the AR-enabled device may be changed. The change of the appearance and location of the object or the action may help the user to develop ability to associate the appearance of the object or the action shown on the picture with other similar objects or actions of the same type.

During the interactive session, a follow-up evaluation of the user may be performed to establish an improvement in the initial skills. The follow-up evaluation may show objects or actions that were unsuccessfully learned by the user. These objects or actions may be repeatedly displayed to the user during the current or following interactive session. Furthermore, other tasks or questions may be selected for the user to teach the unsuccessfully learned material (objects or actions) to the user.

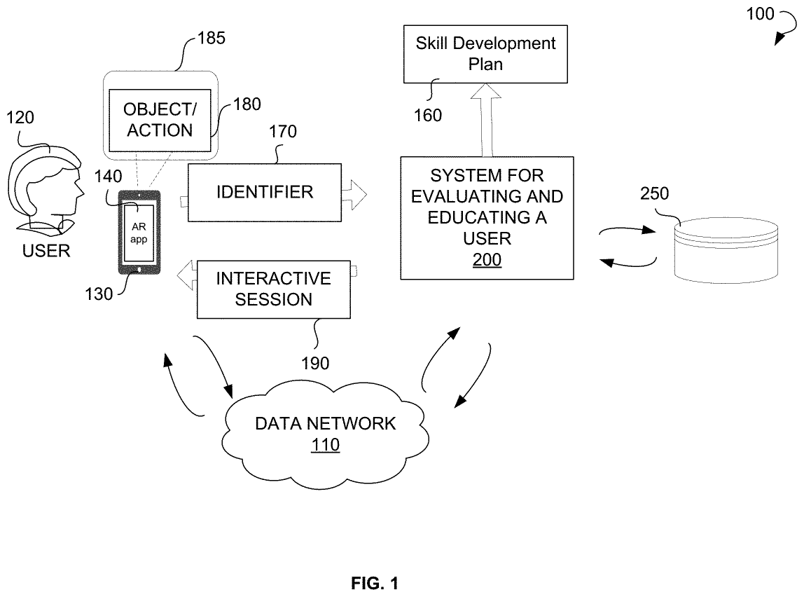

Referring now to the drawings, FIG. 1 illustrates an environment 100 within which methods and systems for evaluating and educating a user can be implemented. The environment 100 may include a data network 110, a user 120, a user device 130, an AR application 140 associated with the user device 130, a system 200 for evaluating and educating a user also referred to as a system 200, and a database 250 associated with the system 200. The user device 130 may be an AR-enabled user device and may include a smartphone, a personal computer (PC), a tablet PC, a personal wearable device, a computing device, and so forth.

The data network 110 may include the Internet, a computing cloud, and any other network capable of communicating data between devices. Suitable networks may include or interface with any one or more of, for instance, a local intranet, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network can further include or interface with any one or more of Recommended Standard 232 (RS-232) serial connection, an IEEE-1394 (FireWire) connection, a Fiber Channel connection, an IrDA (infrared) port, a Small Computer Systems Interface connection, a Universal Serial Bus connection or other wired or wireless, digital or analog interface or connection, mesh or Digi® networking. The data network may include a network of data processing nodes, also referred to as network nodes, that are interconnected for the purpose of data communication.

The user 120 may be tested to determine an initial level of skills and knowledge of the user 120. Based on the testing and, optionally, user data (e.g., information on disorders of the user 120), a skill development plan 160 may be selected or developed for the user 120. Specifically, a plurality of skill development plans may be preliminarily developed for a plurality of possible disorders. In this case, the skill development plan 160 may be selected from the preliminarily developed skill development plans based on the testing results. In another embodiment, the skill development plan 160 may be developed specifically for the user 120 based on the initial level of skills and knowledge and/or disorders of the user 120. The skill development plan 160 may be selected or developed by the system 200. For example, a processing module of the system 200 may select or develop the skill development plan 160 based on the testing results. In another example embodiment, the skill development plan 160 may be selected or developed by a person, for example, a teacher, a parent, a physiologist, a psychologist, and the like.

The skill development plan 160 may include a set of items, such as cards, stickers, or articles. Each of the items may depict an object or an action and may include an AR tag. The AR tag may be an identifier 170 placed on each of the items. The user 120 may activate a camera of the user device 130 and direct the camera view to an item 185 (e.g., a card) depicting an object/action 180. The user device 130 may capture the identifier 170 and activate the AR application 140. The AR application 140 may initiate an interactive session 190 designed to improve the initial skills with respect to the object/action 180. The interactive session 190 may be conducted by presenting the object/action 180 and providing explanations related to the object/action 180 to the user 120 via a screen of the user device 130. Additionally, further objects/actions and corresponding explanations may be displayed to the user 120 via the user device 130 during the interactive session 190.

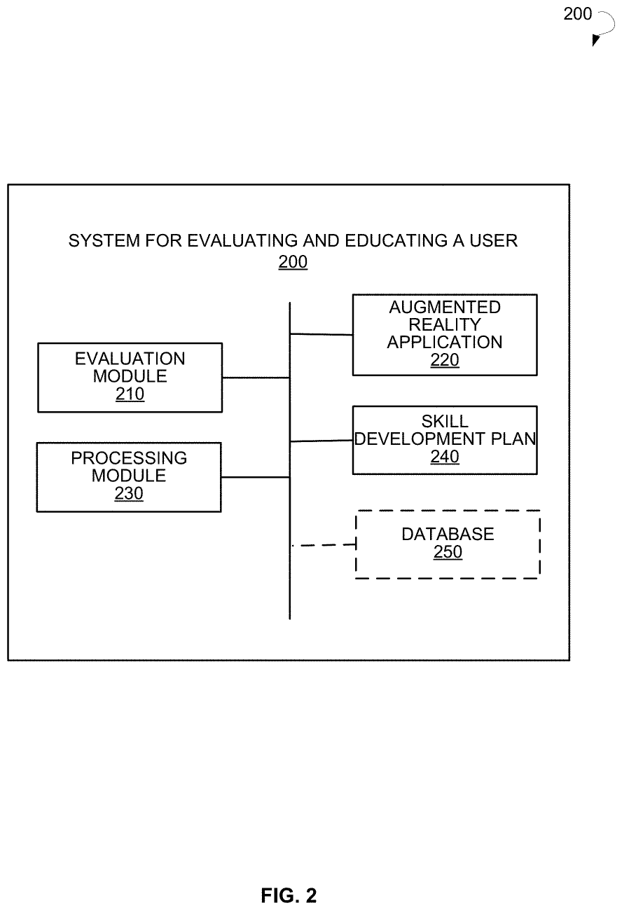

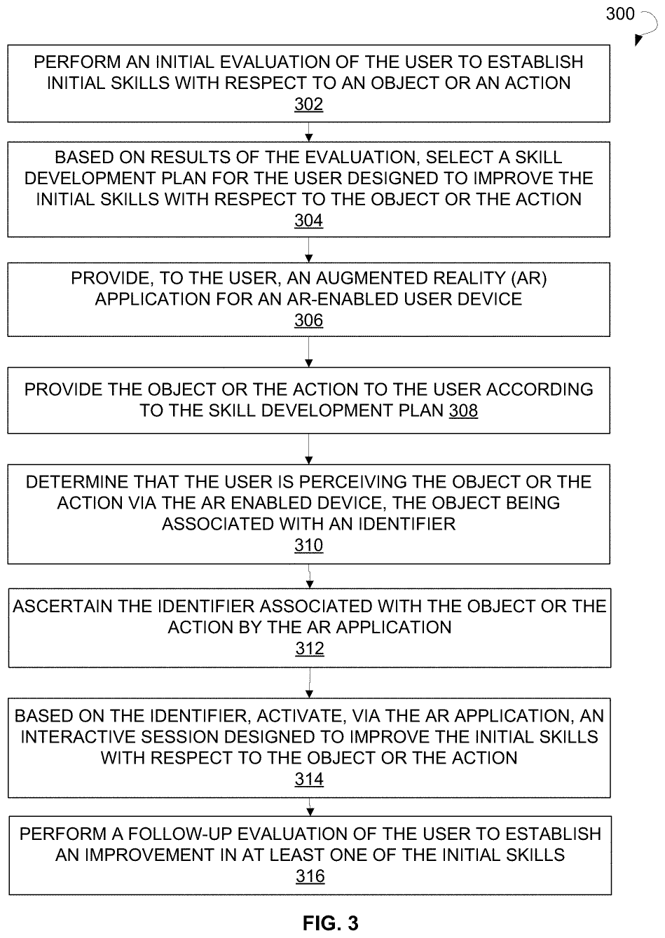

FIG. 2 is a block diagram showing various modules of a system 200 for evaluating and educating a user, in accordance with certain embodiments. Specifically, the system 200 may include an evaluation module 210, an AR application 220, a processing module 230, a skill development plan 240, and optionally a storage unit shown as a database 250. In an example embodiment, each of the evaluation module 210 and the processing module 230 may include a programmable processor, such as a microcontroller, a central processing unit, and so forth. In example embodiments, each of the evaluation module 210 and the processing module 230 may include an application-specific integrated circuit or programmable logic array designed to implement the functions performed by the system 200. Operations performed by each of units of the system 200 are described in detail below with reference to FIG. 3.

FIG. 3 is a flow chart illustrating a method 300 for evaluating and educating a user, in accordance with certain embodiments. In some embodiments, the operations may be combined, performed in parallel, or performed in a different order. The method 300 may also include additional or fewer operations than those illustrated. The method 300 may be performed by processing logic that may comprise hardware (e.g., decision making logic, dedicated logic, programmable logic, and microcode), software (such as software run on a general-purpose computer system or a dedicated machine), or a combination of both.

The method 300 may commence with performing an initial evaluation of the user at operation 302 to establish initial skills with respect to an object or an action. The initial evaluation may be performed by an evaluation module. In an example embodiment, the initial evaluation may include identifying a disorder of the user. The disorder may include at least one of the following: an autism spectrum disorder, a speech disorder, a mental disorder, and so forth. In an example embodiment, the initial evaluation of the user may be directed to detecting a presence of a mental condition, determining a mental condition, determining a physiological condition of the user, and determining a knowledge of the user with respect to objects and actions.

The method 300 may continue with selecting a skill development plan for the user at operation 304. The skill development plan may be designed to improve the initial skills with respect to the object or the action. The skill development plan may be selected based on results of the evaluation of the user by a person that educates the user, such as a parent or a teacher. In an example embodiment, the skill development plan may be selected for the user by a processing module based on the results of the initial evaluation.

In an example embodiment, the skill development plan may include a set of items, such as cards, stickers, plates, sheets, or articles. An AR tag may be placed onto each item of the set. The AR tag may be an identifier configured to be read by a camera of an AR-enabled user device. The skill development plan may further include a training program, an instruction on use of the set of items, such as an order of providing the items to the user, a list of tasks, a list of lessons and a list of specific items to be provided to the user at each lesson, a number of days of a training, and so forth. The skill development plan may include a description of topics, objects, and actions to be studied by the user, a description of the sequence of objects and actions to be presented to the user, a periodicity of presenting objects and actions to the user, and so forth.

An image may be placed on each of the items. The image (a photo, a picture, or other visual image) may depict the object or the action. The object may include any article the meaning of which the user needs to learn (e.g., a flower, a wardrobe, a car, an animal, a book, and so forth). The action may include any action the meaning of which the user needs to learn (e.g., running, walking, swimming, flying, doing, and so forth). The action may be depicted by showing a character performing the action (e.g., a running cartoon character may be shown for the action “run”).

The method 300 may further include providing, to the user, an AR application for the AR-enabled user device at operation 306. The AR-enabled user device may include a smartphone or a tablet PC.

The method 300 may continue with providing the object or the action to the user according to the skill development plan at operation 308. The object or the action may be associated with a card, a sticker, a sample representation, a sound, and so forth. Specifically, the object or the action may be depicted on the card, the sticker, or the sample representation, or the object or the action may be presented via a sound. The card, the sticker, or the sample representation may be placed by the user in front of the camera of the AR-enabled user device. The camera of the AR-enabled user device may detect the identifier in the card, the sticker, or the sample representation.

The method 300 may further include determining, at operation 310, that the user is perceiving the object or the action via the AR-enabled user device. The object or the action may be associated with the identifier. Specifically, based on capturing of the identifier, the AR-enabled user device may determine that the user is perceiving the object or the action via the AR-enabled user device.

At operation 312, the identifier associated with the object or the action may be ascertained by the AR application. Based on the identifier, an interactive session may be activated via the AR application at operation 314. The interactive session may be designed to improve the initial skills with respect to the object or the action.

The user may interact with the AR application via an interactive interface during the interactive session. Specifically, the user may select answers which the user believes are correct, respond to questions, solve tasks and play quest games related to the object or action, and so forth.

In a further example embodiment, the interactive session may include providing a test, a question, and/or a task to the user, receiving a response from the user, and selectively providing, based on the response, additional objects, actions, or tests to reinforce the response of the user. The tests, questions, and/or tasks may include or be associated with explanations or specifications relating to the object or action and may further describe the meaning and other peculiarities of the object or action.

In an example embodiment, the interactive session may be performed by presenting a word to the user. The word may be associated with the object or the action. The word may be presented via the AR-enabled user device by displaying the word on a screen or reproducing the word using an audio unit of the AR-enabled user device. The word presented to the user may be accompanied by displaying a plurality of further objects or actions related to the word. In addition to presenting the word, the explanation of the word, i.e., the explanation of the object or action denoted by the word, the purpose of the object or action, and other features/properties of the objects or actions may be presented to the user via the AR-enabled user device. The AR application may present the object or action and accompanying explanations in a form of interactive animation. The interactive animation may be provided in the form of AR objects on a screen of the AR-enabled user device. The interactive animation may be a combination of visual and audio information directed to stimulate visual and auditory channels of information perception of the user. Furthermore, the motor memory of the user may be engaged when the user needs to manipulate the user device or provide responses in the AR application. The activation of multiple channels of information perception and the motor memory of the user may increase the efficiency of perception of information and may help the user to learn the material.

In a further example embodiment, the interactive session may include repeated pronunciations of a word by varying voices having different voice parameters. The voice parameters may include a speed, a vocal range, and so forth.

In a further example embodiment, the interactive session may include presenting buttons having varying parameters. The varying parameters may include a shape, a color, a size, a font, and a location on a screen of the AR-enabled user device.

In an example embodiment, the interactive session may include presenting, to the user via the AR-enabled user device, an animation designed to explain a meaning of the object or the action.

The method 300 may continue with performing a follow-up evaluation of the user at operation 316. The follow-up evaluation of the user may be performed to establish an improvement in at least one of the initial skills of the user. For example, the follow-up evaluation may include determining whether the user understands the meaning of the object or action. Based on the follow-up evaluation, the skill development plan may be modified. Specifically, it may be determined that some of the objects and actions are not learned by the user. These objects and actions may be placed into the skill development plan for further learning by the user. Furthermore, additional objects, actions, tasks, questions, tests, and game quests may be added into the skill development plan. Therefore, the process of teaching of the user may include the combination of training (in the form of presenting objects and actions to the user) and testing (in the form of evaluating whether the user provided correct responses to questions) of the user. The testing may be performed throughout the training, namely, at the beginning of the training/lesson to test initial level of knowledge of the user and mental state, after explanation of objects and actions to determine the level of retention of the material related to the objects and actions, and at the end of the training/lesson to determine the results of the training/lesson.

In an example embodiment, the skill development plan may be dynamically adapted based on the follow-up evaluation. Specifically, objects and actions that were not learned by the user as shown by the follow-up evaluation may be added to further interactive sessions of the skill development plan, and further objects and actions to be learned by the user may be added to the skill development plan based on the follow-up evaluation. The actions made by the user in the AR application, mistakes of the user, and correct answers may be recorded to the database as user data. The results of the follow-up evaluation may be further added to the user data in the database. The dynamic modification of the skill development plan may be performed based on the user data continuously collected by one or more of the AR application, the AR-enabled user device, a teacher, a parent, and so forth.

Additionally, the AR application may provide notifications to the teacher or parent informing the results of the follow-up evaluation and recommending further objects, actions, lessons, and topics to the learned by the user.

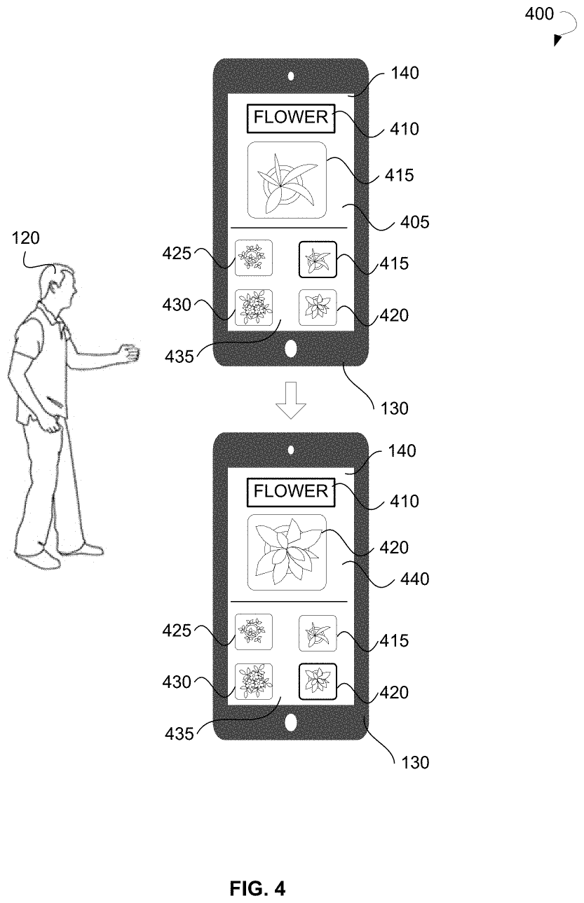

FIG. 4 is a schematic diagram 400 illustrating a method for educating a user to develop an association between a visual representation of objects and real objects, i.e., the objects per se, according to an example embodiment. In an example embodiment, the method may be used for educating users suffering from autism spectrum disorders and other mental disorders to identify objects using mobile applications, computer programs, and Internet services. The method solves the problem of inability of users to develop an association between real objects and visual images of the objects.

The users having aforementioned disorders may be able to create a limited association of real objects with visual images of real objects or may be unable to create any association. For example, if the picture shows a red cabinet, the user may consider only a cabinet of the same shape and the same red color to be the cabinet. The user may be unable to recognize a cabinet of other shape, size, or color to be a cabinet. Such peculiarities of perception by the user may limit the ability of the user to understand the real world and use services for training the users, such as mobile applications, computer programs, and Internet services.

To expand the associative array for objects of the user, the method includes demonstrating an object multiple times. Each time the object is presented, the shape, size, and color of the object may be changed. For example, when the object “flower” is described, multiple images of a flower may be sequentially presented to the user, and each flower on the images may have a differing shape, size, and color.

As shown on FIG. 4, a user 120 may interact with an AR application 140 running on a user device 130. A user interface 405 may be presented to the user 120. On the user interface 405, an object 410 may be presented. For example, the object 410 may include a word “flower.” Specifically, the object “flower” may be selected to teach the user 120 to create an association between the word “flower” and flowers in real life. Along with presenting the object 410, a first image 415 showing a first type of a flower may be presented to the user 120.

The AR application 140 may have a plurality of images for each object present in a skill development plan. Specifically, the AR application 140 may store a plurality of images of different flowers, such as the first image 415, the second image 420, the third image 425, and the fourth image 430. Each of the first image 415, the second image 420, the third image 425, and the fourth image 430 may explain the object 410.

The images may be stored in a database associated with the AR application 140. Though FIG. 4 shows a gallery 435 of images associated with the object 410 shown on the user interface 405, the gallery 435 may not be shown to the user 120 along with presenting the first image 415. In other words, only the object 410 and one image, such as the first image 415, may be presented to the user 120 on the user interface 405.

After presenting the first image 415 to the user on the user interface 405, a user interface 440 may be provided to the user 120. On the user interface 440, the same type of object 410 may be presented to the user 120. Along with presenting the object 410, a second image 425 showing a second type of a flower may be presented to the user 120.

At further steps of the method for educating a user, the third image 425 and the fourth image 430 may be sequentially presented to the user 120 along with presenting the object 410.

Therefore, the user 120 may be presented with an array of images which the user may associate with the object 410. Sequential providing of images showing the object 410 in various shapes, sizes, and colors may stimulate the user 120 to develop the skill of generalization (i.e., the skill of making the correlation of objects of different shapes and colors with the concept of the object).

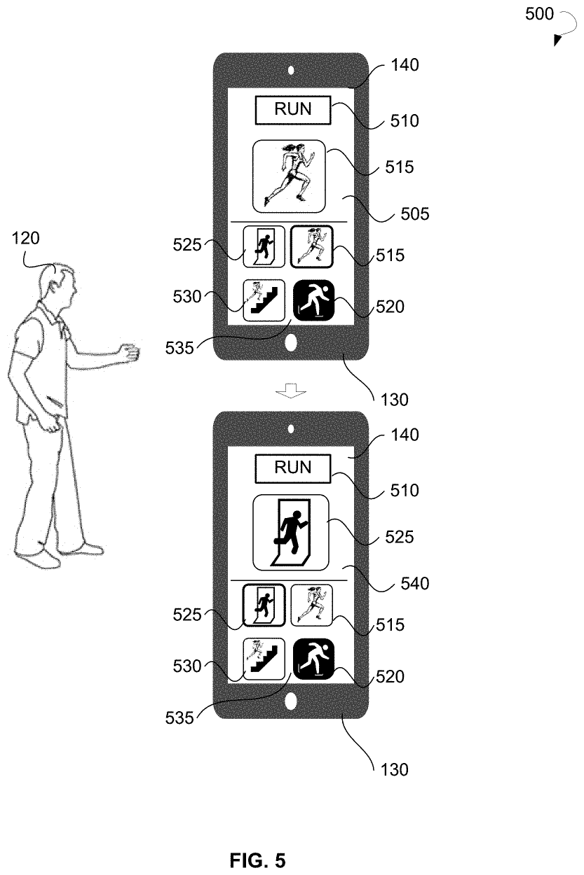

FIG. 5 is a schematic diagram 500 illustrating a method for educating a user to develop an association between a visual representation of actions and real actions, i.e., the actions per se, according to an example embodiment. In an example embodiment, the method may be used for educating users suffering from autism spectrum disorders and other mental disorders to recognize objects with the help of mobile applications, computer programs, and Internet services. The method solves the problem of inability of users to develop an association between real actions and visual representations of the actions.

The users having aforementioned disorders may be able to create a limited association of actions with visual representations of actions or may be unable to create any association. For example, if an animation shows a running man of a particular age and gender, the user may associate the action “run” only with this specific person of a particular age and gender. The user may be unable to recognize the action of running when the running is performed by any other person or animal. Such peculiarities of perception by the user may limit the ability of the user to understand the real world and use services for training the user, such as via mobile applications, computer programs, and Internet services.

As shown on FIG. 5, a user 120 may interact with an AR application 140 running on a user device 130. A user interface 505 may be presented to the user 120. On the user interface 505, an action 510 may be presented. For example, the action 510 may include a word “run.” Specifically, the action “run” may be selected to teach the user 120 to create an association between the word “run” and the action of running in real life. Along with presenting the action 510, a first image 515 showing a running woman may be presented to the user 120.

The AR application 140 may have a plurality of images for each action present in a skill development plan. Specifically, the AR application 140 may store a plurality of images showing the action of running, such as the first image 515, the second image 520, the third image 525, and the fourth image 530. Each of the first image 515, the second image 520, the third image 525, and the fourth image 530 may explain the action 510.

In an example embodiment, each of the first image 515, the second image 520, the third image 525, and the fourth image 530 may include an animated ‘moving’ image showing the action of running in various scenarios. The images may be stored in a database associated with the AR application 140.

Though FIG. 5 shows a gallery 535 of images associated with the action 510 shown on the user interface 405, the gallery 535 may not be shown to the user 120 along with presenting the first image 515. In other words, only the action 510 and one image, such as the first image 515, may be presented to the user 120 on the user interface 505.

After presenting the first image 515 to the user on the user interface 505, a user interface 540 may be provided to the user 120. On the user interface 540, the same action 510 may be presented to the user 120. Along with presenting the action 510, a second image 525 showing a running man may be presented to the user 120.

At further steps of the method for educating a user, the third image 525 and the fourth image 530 may be sequentially presented to the user 120 along with presenting the action 510.

Therefore, the user 120 may be presented with an array of images which the user may associate with the action 510. Sequential providing of images showing the action 510 in various forms may stimulate the user 120 to develop the skill of generalization (i.e., the skill of making the correlation of actions made by different persons or animals, at different locations and conditions with the concept of the action).

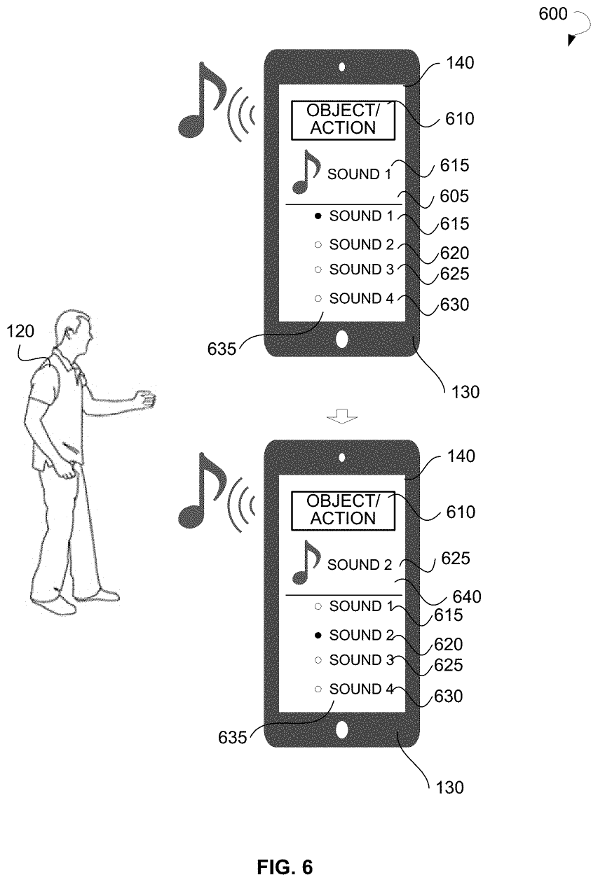

FIG. 6 is a schematic diagram 600 illustrating a method for educating a user to develop an association between an audible representation (e.g., a spoken word) of objects or actions and real objects or actions or visual representation of objects or actions, according to an example embodiment. In an example embodiment, the method may be used for educating users suffering from autism spectrum disorders and other mental disorders to recognize objects with using mobile applications, computer programs, and Internet services. The method solves the problem of inability of users to develop an association between real objects or actions and audible representation of the objects and actions.

The users having aforementioned disorders may be able to create a limited association of objects or actions with audial representations of objects or actions or may be unable to create any association. For example, if a speaker or a person pronounces a word that means an object or an action, the user may associate the object or the action only with a voice of this particular speaker or person. Specifically, the user may associate the object or the action only with a voice having specific characteristics, such as pitch of a tone and speed of speech.

The user may be unable to recognize the object or action when the object or action is presented by a voice of any other person. Such peculiarities of perception by the user may limit the ability of the user to understand the world and use services for training the users, such as via mobile applications, computer programs, and Internet services.

As shown on FIG. 6, a user 120 may interact with an AR application 140 running on a user device 130. A user interface 605 may be presented to the user 120. On the user interface 605, an object/action 610 may be presented. The object/action 610 may include a word denoting an object or an action. Specifically, the object/action 610 may be selected to teach the user 120 to create an association between the audial representation of the object/action 610 and the object/action in real life. Along with presenting the object/action 610, a first sound 615 may be presented to the user 120. The first sound 615 may be an audio recording of pronunciation of the object/action 610 by a person. The first sound 615 may have a first set of characteristics.

The AR application 140 may have a plurality of audio files for each object/action present in a skill development plan. Specifically, the AR application 140 may store a plurality of audio files shown as the first sound 615, the second sound 620, the third sound 625, and the fourth sound 630. Each of the first sound 615, the second sound 620, the third sound 625, and the fourth sound 630 may explain the object/action 610.

In an example embodiment, each of the first sound 615, the second sound 620, the third sound 625, and the fourth sound 630 may be an audible representation of the object/action 610, where each of the first sound 615, the second sound 620, the third sound 625, and the fourth sound 630 may have different sets of characteristics, such as different pitch of the sound, different speech speed, and so forth. The audible representations may be stored in a database associated with the AR application 140. Thus, the AR application 140 may use a predetermined algorithm to select different audible representations each time the object/action 610 is presented on the screen. In an example embodiment, the AR application 140 may modify the same audible representation to create different audible representations for each presentation of the object/action 610 on the screen.

Though FIG. 6 shows a gallery 635 of audible representations associated with the object/action 610 shown on the user interface 605, the gallery 635 may not be shown to the user 120 along with presenting the first sound 615. In other words, only the object/action 610 and one sound, such as the first sound 615, may be presented to the user 120 on the user interface 605.

After presenting the first sound 615 to the user on the user interface 605, a user interface 640 may be provided to the user 120. On the user interface 640, the same object/action 610 may be presented to the user 120. Along with presenting the object/action 610, a second sound 620 having pitch and speed differing of those of the first sound 615 may be presented to the user 120.

At further steps of the method for educating a user, the third sound 625 and the fourth sound 630 may be sequentially presented to the user 120 along with presenting the object/action 610.

Therefore, the user 120 may be presented with an array of audible samples which the user may associate with the object/action 610. Sequential providing of audible representations of the object/action 610 using various pitch and speech speed may stimulate the user 120 to develop the skill of generalization (i.e., the skill of making the correlation of objects/actions pronounced by different persons with the concept of the objects/actions).

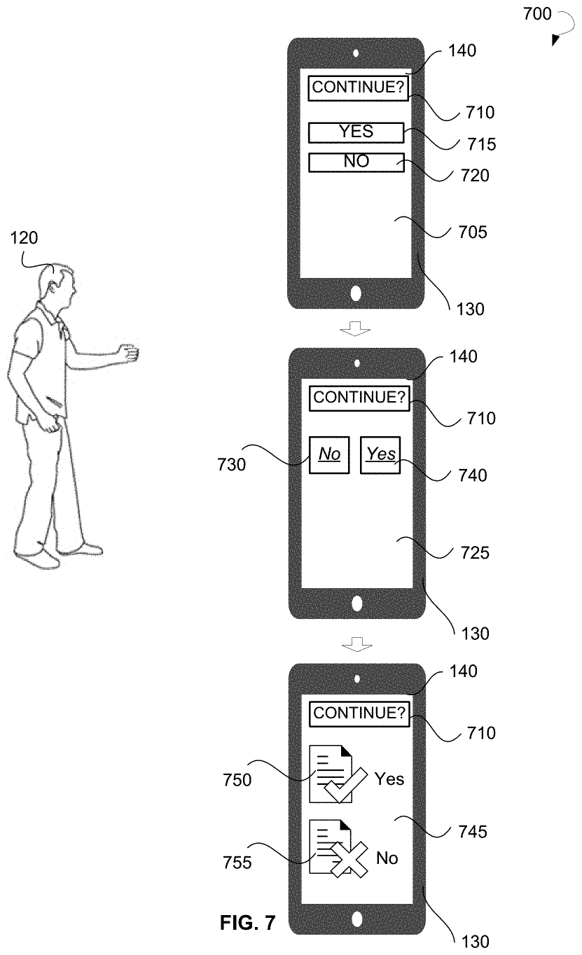

FIG. 7 is a schematic diagram 700 illustrating a method for educating a user to avoid developing a stereotypical behavior with regard to objects shown on a screen of a computing device, according to an example embodiment. In an example embodiment, the method may be used for educating users suffering from autism spectrum disorders and other mental disorders to avoid a stereotypical behavior when using mobile applications, computer programs, and Internet services. Specifically, the users having mental disorders may have a stereotypical behavior of repetition of the same actions. When the user uses the computing device, windows with buttons that offer a binary choice (Yes/No, Back/Next, Accept/Cancel, etc.) or the choice of one of several options for action (or answer to a question) may be presented to the user. In a case of stereotypical behavior, the user does not think about the meaning of the action being performed, but automatically presses a button located on the same place on the screen as a place of a button the used pressed in response to a previous question. In other words, when the material is repeated, the user mechanically repeats the same movement and gets the correct result. However, in the case providing training and rehabilitation services via computing devices, the user needs to develop not a mechanical skill but an ability to make a conscious choice of the required action.

As shown on FIG. 7, a user 120 may interact with an AR application 140 running on a user device 130. A user interface 705 may be presented to the user 120. On the user interface 705, an object/action 710 may be presented. The object/action 710 may be presented in a form of a sentence, a question (e.g., “Continue?”), and the like. Specifically, the object/action 710 may be selected to teach the user 120 to develop a conscious choice skill. Along with presenting the object/action 710, two options may be provided for selecting by the user 120, namely the first button 715 and the second button 720. The user 120 may respond to the question asked in the object/action 710 by pressing any of first button 715 and the second button 720.

The next time the object/action 710 is repeatedly presented to the user 120, a user interface 725 may be provided to the user 120. On the user interface 725, the same object/action 710 may be presented to the user 120. Along with presenting the object/action 710, two options may be provided for selecting by the user 120, namely the first button 730 and the second button 740. The appearance (e.g., shape, size, color) and/or location on the screen of the first button 730 and the second button 740 may differ from the appearance and location on the screen of the first button 715 and the second button 720.

Similarly, the next time the object/action 710 is repeatedly presented to the user 120, a user interface 745 may be provided to the user 120. On the user interface 745, the same object/action 710 may be presented to the user 120. Along with presenting the object/action 710, two options may be provided for selecting by the user 120, namely the first button 750 and the second button 755. The appearance (e.g., shape, size, color) and/or location on the screen of the first button 750 and the second button 755 may differ from the appearance and location on the screen of the first button 715 and the second button 720, as well as from the appearance and location on the screen of the first button 730 and the second button 740. Thus, the AR application 140 may use a predetermined algorithm to select different types of elements (e.g., rectangular buttons and round buttons), font types, colors, sizes, and different variants of disposition of the elements on the screen of the user device 130 each time the object/action 710 is presented on the screen.

Therefore, each time the user 120 is presented with the object/action 710, the user 120 cannot repeat an unconscious selection of a button the user 120 selected last time but needs to make a conscious choice of the button to correctly answer the question represented by the object/action 710.

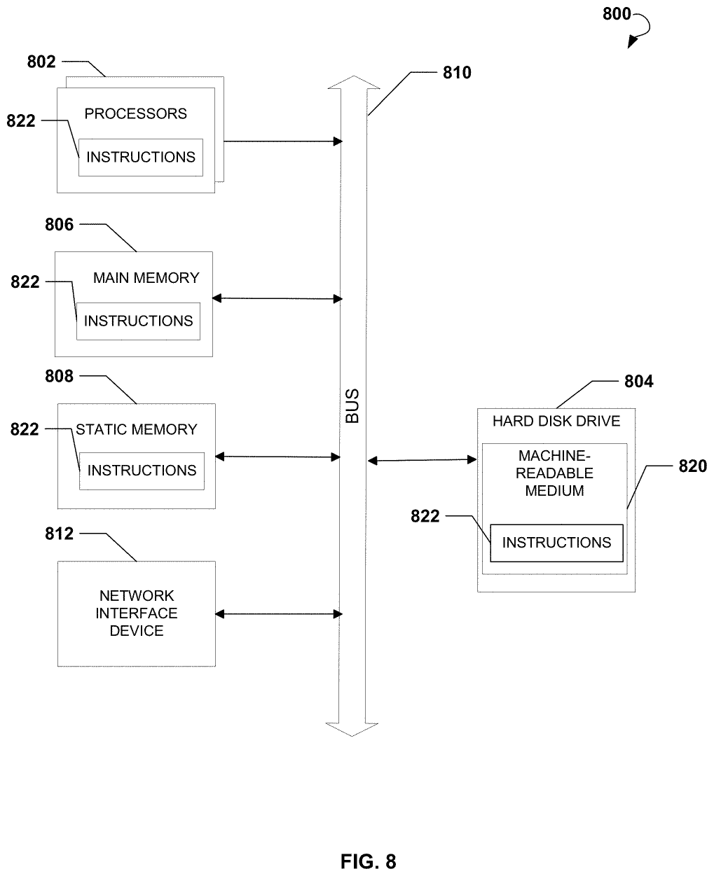

FIG. 8 shows a diagrammatic representation of a computing device for a machine in the exemplary electronic form of a computer system 800, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a PC, a tablet PC, a set-top box, a cellular telephone, a digital camera, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 800 may include a processor or multiple processors 802, a hard disk drive 804, a main memory 806 and a static memory 808, which communicate with each other via a bus 810. The computer system 800 may also include a network interface device 812. The hard disk drive 804 may include a computer-readable medium 820, which stores one or more sets of instructions 822 embodying or utilized by any one or more of the methodologies or functions described herein. The instructions 822 can also reside, completely or at least partially, within the main memory 806 and/or within the processors 802 during execution thereof by the computer system 800. The main memory 806 and the processors 802 also constitute machine-readable media.

While the computer-readable medium 820 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, Random Access Memory, Read-Only Memory, and the like.

The example embodiments described herein may be implemented in an operating environment comprising software installed on a computer, in hardware, or in a combination of software and hardware.

In some embodiments, the computer system 800 may be implemented as a cloud-based computing environment, such as a virtual machine operating within a computing cloud. In other embodiments, the computer system 800 may itself include a cloud-based computing environment, where the functionalities of the computer system 800 are executed in a distributed fashion. Thus, the computer system 800, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer system 800, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

Thus, methods and systems for evaluating and educating a user are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

What is claimed is:

1. A method for evaluating and educating a user, the method comprising:
performing an initial evaluation of the user to establish initial skills with respect to an object or an action;
based on results of the evaluation, selecting a skill development plan for the user designed to improve the initial skills with respect to the object or the action;
providing, to the user, an augmented reality (AR) application for an AR-enabled user device;
providing the object or the action to the user according to the skill development plan;
determining that the user is perceiving the object or the action via the AR-enabled user device, the object or the action being associated with an identifier;
ascertain the identifier associated with the object or the action by the AR application;
based on the identifier, activating, via the AR application, an interactive session designed to improve the initial skills with respect to the object or the action; and
performing a follow-up evaluation of the user to establish an improvement in at least one of the initial skills.

2. The method of claim 1, wherein the initial evaluation includes identifying a disorder, the disorder including at least one of the following: an autism spectrum disorder, a speech disorder, and a mental disorder.

3. The method of claim 1, wherein the interactive session includes:
presenting a word; and
displaying a plurality of further objects or actions related to the word.

4. The method of claim 1, wherein the interactive session includes repeated pronunciations of a word by varying voices having different voice parameters, the voice parameters including one or more of a speed and a vocal range.

5. The method of claim 1, wherein the interactive session includes presenting buttons having varying parameters, the varying parameters including a shape, a color, a size, a font, and a location on a screen of the AR-enabled user device.

6. The method of claim 1, wherein the interactive session includes presenting, to the user via the AR-enabled user device, an animation designed to explain a meaning of the object or the action.

7. The method of claim 1, wherein the interactive session includes:
providing a test to the user;
receiving a response from the user;
based on the response, selectively providing additional objects, actions, or tests to reinforce the response.

8. The method of claim 1, wherein the object or the action is associated with a card, a sticker, a sample representation, or a sound.

9. The method of claim 1, wherein the AR-enabled user device includes a smartphone or a tablet personal computer.

10. A system for evaluating and educating a user, the system comprising:
an evaluation module configured to perform an initial evaluation of the user to establish initial skills with respect to an object or an action;
a skill development plan selected based on results of the evaluation, the skill development being designed to improve the initial skills with respect to the object or the action;
an augmented reality (AR) application designed to present, to the user via an AR-enabled user device, the object according to the skill development plan; and
a processing module configured to:
determine that the user is perceiving the object or the action via the AR-enabled user device, the object or the action being associated with an identifier;
ascertain, by the AR application, the identifier associated with the object or the action; and
based on the identifier, activate, on the AR-enabled user device, an interactive session designed to improve the initial skills with respect to the object or the action, wherein the evaluation module is to perform a follow-up evaluation of the user to establish an improvement in at least one of the initial skills.

11. The system of claim 10, wherein the initial evaluation includes identifying a disorder, the disorder including at least one of the following: an autism spectrum disorder, a speech disorder, and a mental disorder.

12. The system of claim 10, wherein the interactive session includes:
presenting a word; and
displaying a plurality of further objects or actions related to the word.

13. The system of claim 10, wherein the interactive session includes repeated pronunciations of a word by varying voices having different voice parameters, the voice parameters including one or more of a speed and a vocal range.

14. The system of claim 10, wherein the interactive session includes presenting buttons having varying parameters, the varying parameters including a shape, a color, a size, a font, and a location on a screen of the AR-enabled user device.

15. The system of claim 10, wherein the interactive session includes presenting, to the user via the AR-enabled user device, an animation designed to explain a meaning of the object or the action.

16. The system of claim 10, wherein the interaction includes:
providing a test to the user;
receiving a response from the user;
based on the response, selectively providing additional objects, actions, or tests to reinforce the response.

17. The system of claim 10, wherein the object or the action is associated with a card, a sticker, a sample representation, or a sound.

18. The system of claim 10, wherein the AR-enabled user device includes a smartphone or a tablet personal computer.

19. A non-transitory computer readable storage medium having embodied thereon a program, the program being executable by a processor to perform a method for evaluating and educating a user, the method comprising:
performing an initial evaluation of the user to establish initial skills with respect to an object or an action;
based on results of the evaluation, selecting a skill development plan for the user designed to improve the initial skills with respect to the object or the action;
providing, to the user, an augmented reality (AR) application for an AR-enabled user device;
providing the object or the action to the user according to the skill development plan;
determining that the user is perceiving the object or the action via the AR-enabled user device, the object or the action being associated with an identifier;
ascertaining the identifier associated with the object or the action by the AR application;
based on the identifier, activating, via the AR application, an interactive session designed to improve the initial skills with respect to the object or the action; and
performing a follow-up evaluation of the user to establish an improvement in at least one of the initial skills.

20. The non-transitory computer readable storage medium of claim 19, wherein the initial evaluation includes identifying a disorder, the disorder including at least one of the following: an autism spectrum disorder, a speech disorder, and a mental disorder.
